(19) United States
(12) Patent Application Publication
(10) Pub. No.: US 2010/0053475 A1
(43) Pub. Date: Mar. 4, 2010

(54) ILLUMINATED STATUS INDICATOR FOR AN IMAGE DISPLAY DEVICE

(75) Inventors: Danny Han, Happy Valley, OR (US); Chris Valentine, Portland, OR (US); Alexander Benenson, Salem, OR (US); Ross Kruse, Salem, OR (US); Robert David Woolf, Lake Oswego, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/552,462

(22) Filed: Sep. 2, 2009

Related U.S. Application Data
(60) Provisional application No. 61/094,013, filed on Sep. 3, 2008.

(51) Int. Cl. H04N 5/64; G08B 5/00

(52) U.S. Cl. 348/744; 340/815.65; 348/E05.137

(57) ABSTRACT

Systems and methods for an illuminating status indicator for an image display device are provided. In one example, an image display device is provided including a light source, an image generating element configured to receive light from the light source, and in response, generate an image, a projection lens configured to display the image on a viewing surface, and an illuminated status indicator configured to visually indicate a status of the image display device and extending at least partially around the projection lens. The example image display device further may include a control system in communication with the light source, the image generating element, and the illuminated status indicator and a housing comprised of a plurality of faces, where the housing encloses the light source, the image generating element, and the control system and where the illuminated status indicator is viewable by a user when the user is looking at a face of the housing.

### CROSS-REFERENCE TO RELATED APPLICATIONS

This application claims priority from U.S. Provisional Patent Application No. 61/094,013 of Danny Han, Chris Valentine, Alexander Benenson, Ross Kruse, and Robert D. Woolf, entitled “ILLUMINATED STATUS INDICATOR FOR AN IMAGE DISPLAY DEVICE,” filed Sep. 3, 2008, the disclosure of which is hereby incorporated by reference in its entirety and for all purposes.

### FIELD

The present application relates to systems, apparatus, and methods for an illuminated status indicator for an image display device.

### BACKGROUND AND SUMMARY

An image display device, such as a projector, may be mounted such that a user is not directly adjacent to the image display device. For example, some image display devices are permanently mounted on the ceiling or on an upper portion of a wall. Further, some image display devices are positioned in the back of a room such that access to the image display device is difficult. With such image display devices, remote controls or other remote input devices may be used to control the image display device. Some image display devices may include a power button with an indicator light, but such power buttons are usually small and difficult to view from a distance. Furthermore, the user's view of the power button may be blocked by the image display device when the power button is facing away from the user. As such, it may be difficult to promptly detect when an image display device is powered on.

This difficulty may be compounded as many image display devices may appear inoperative or non-responsive due to long delays between actions directed to the image display device and a change in the behavior of the image display device. For example, many projectors have a warm-up period during which a light source warms up before images can be projected onto a viewing surface. A user of the projector may become frustrated during the warm-up period as it may be difficult for the user to determine if the remote control has caused the projector to turn on. Some users will then continually press the power button on and off or believe that there is something wrong with the projector.

The inventors herein have recognized that existing power indicators of image display devices may be difficult for a user to identify, especially when the image display device is placed remotely. In addition, the delays between user action and image display device response may further confuse and frustrate the user.

One approach to address the above issues is an image display device including a light source, an image generating element configured to receive light from the light source, and in response, generate an image, a projection lens configured to display the image on a viewing surface, and an illuminated status indicator configured to visually indicate a status of the image display device and extending at least partially around the projection lens. The example image display device further may include a control system in communication with the light source, the image generating element, and the illuminated status indicator and a housing comprised of a plurality of faces, where the housing encloses the light source, the image generating element, and the control system and where the illuminated status indicator is viewable by a user when the user is looking at a face of the housing.

Furthermore, a complementary approach to address the above issues includes a method for operating an image display device including a light source, an image generating element, and an illuminated status indicator with at least one segment. The method may include determining a current image display device state from a plurality of image display device states, associating the current image display device state to a desired illuminated status indicator mode, and adjusting an illuminated status indicator illumination according to the desired illuminated status indicator mode. In this way, an image display device including an illuminated status indicator may enable a user to promptly identify the status of the image display device. User frustration and impatience with the image display device may be reduced and the user experience with the image display device may be improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a block diagram of an example embodiment of an image display device.

FIG. 2 shows a front perspective of an example image display device with an illuminated status indicator according to an embodiment of the present disclosure.

FIG. 3 shows a rear perspective of the image display device in FIG. 2.

FIGS. 4A-4H show various example embodiments of a face of the image display device illustrating how a projection lens and illuminated status indicator may be arranged on the face.

FIG. 5 illustrates an alternative embodiment of an image display device with an illuminated status indicator.

FIG. 6 shows a high level flow chart for controlling an illuminated status indicator of an image display device.

FIG. 7 shows a high level flow chart for determining the current image display device state.

FIG. 8 shows a high level flow chart for adjusting the illumination of an illuminated status indicator of an image display device.

### DETAILED DESCRIPTION

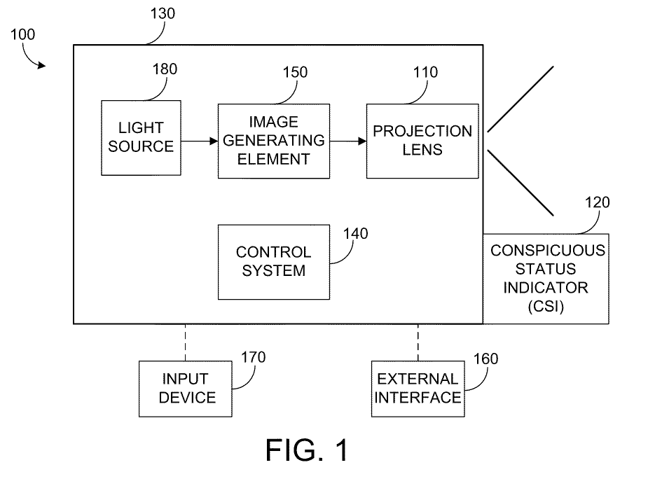

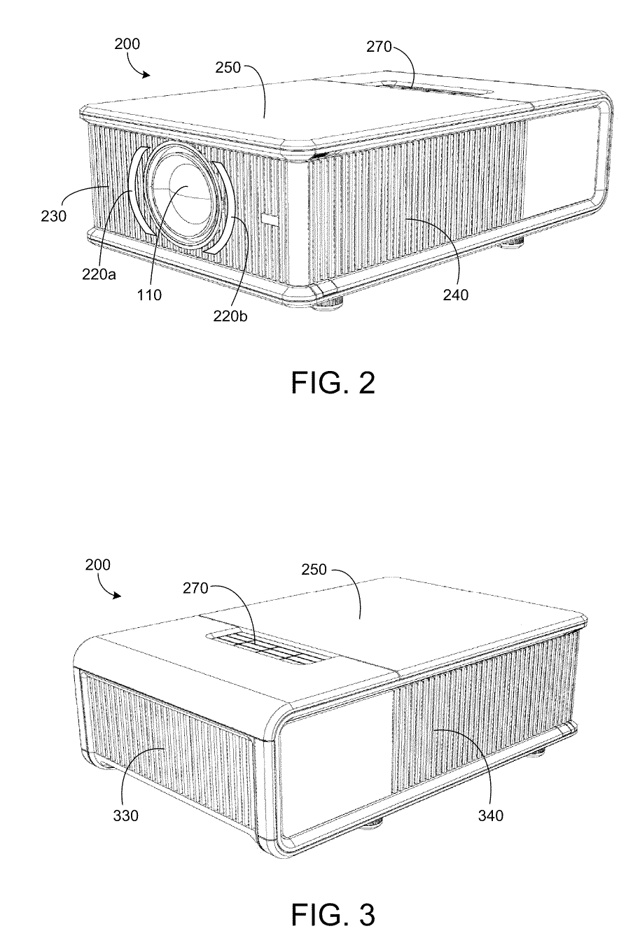

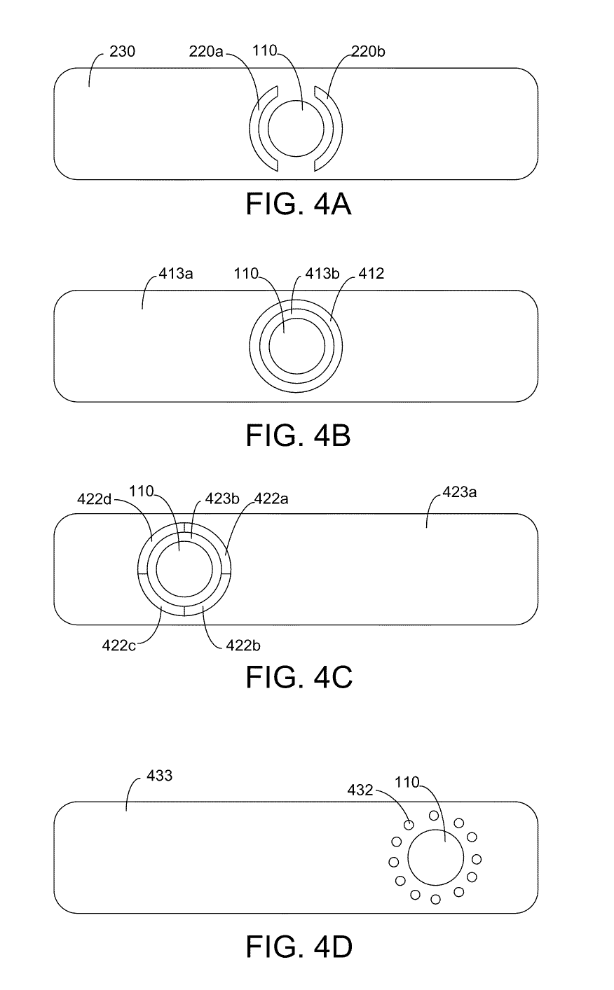

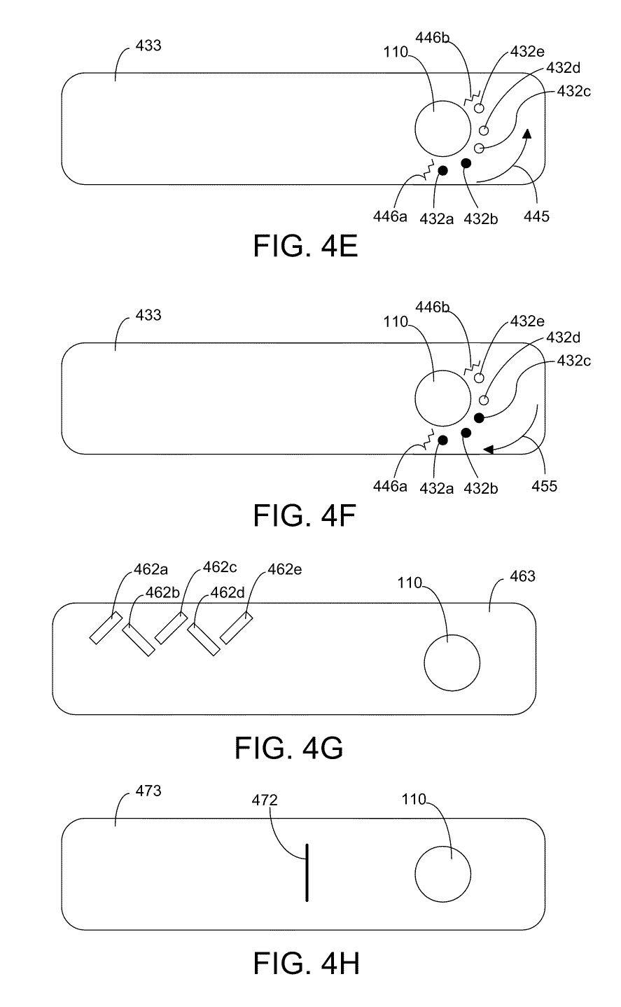

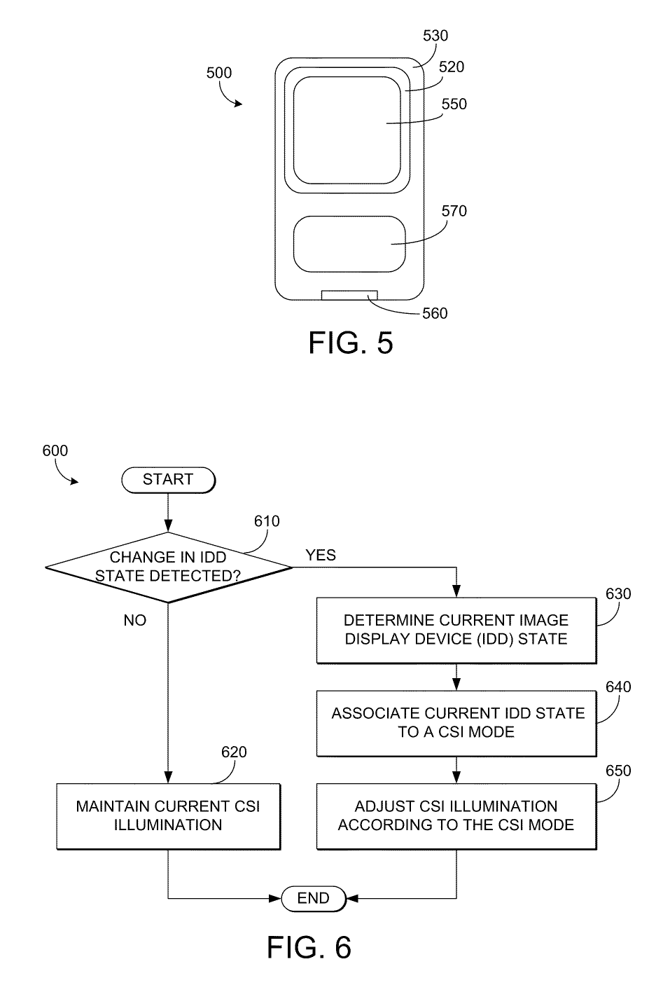

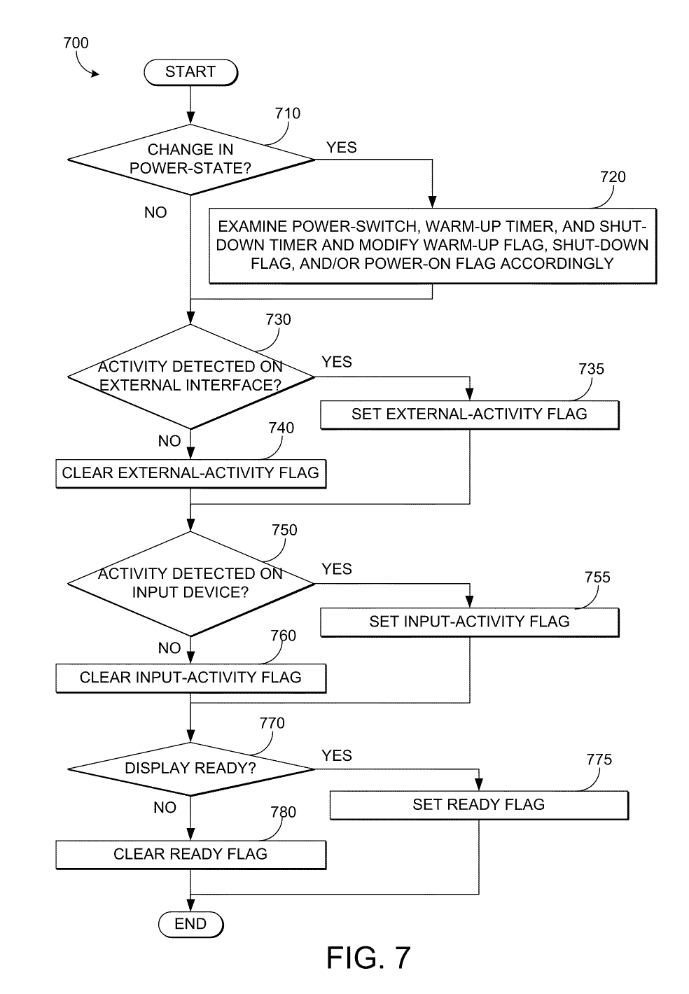

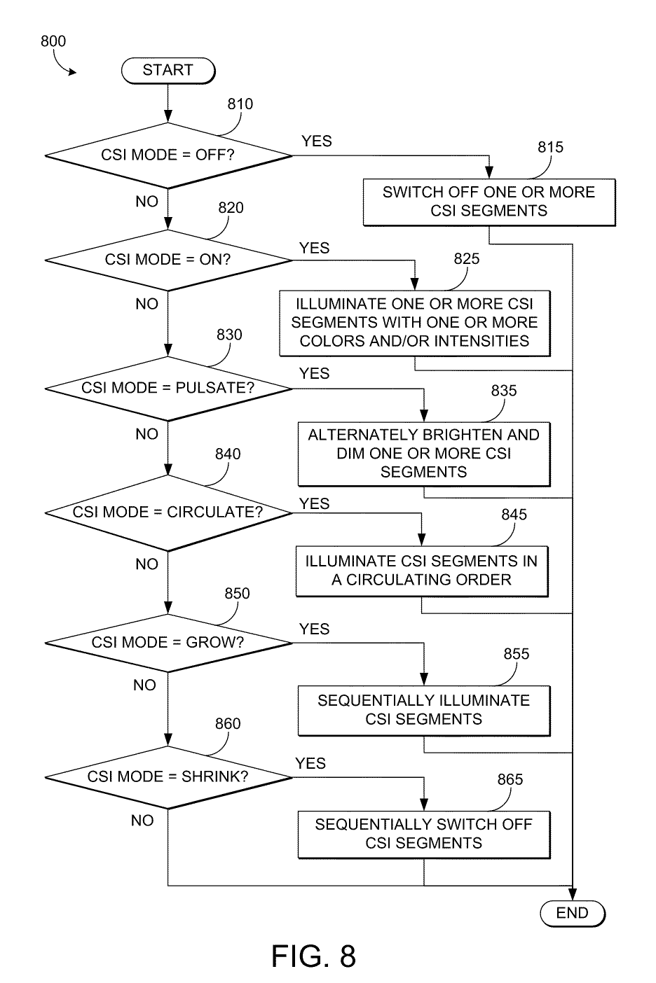

The following description relates to systems and methods for indicating the status of an image display device. A block diagram of an example embodiment of an image display device including an illuminated status indicator also referred to as a conspicuous status indicator (CSI) is described in FIG. 1. An example image display device is illustrated from two different perspectives in FIGS. 2-3. In FIG. 2, three faces of the image display device are shown, where one of the faces includes an opening for a projection lens and a CSI. FIGS. 4A-4H are focused on a single face of the image display device, showing various example embodiments of how a projection lens and a CSI may be arranged on a face of the image display device. FIG. 5 illustrates an alternative embodiment of an image display device with a CSI, where the image display device is not a projector. FIG. 6 shows a high level flow chart for controlling a CSI included as part of an image display device. The CSI visually presents the state of the image display device to a user according to a CSI mode. FIG. 7 shows an example of how the current image display device state may be determined. FIG. 8 shows an example of how the CSI mode, associated with the image display device state, may be used to control the illumination of the CSI.

Referring more specifically to FIG. 1, a block diagram of an example embodiment of an image display device. In this example, the image display device is a front projection device that may be configured to be mounted onto a ceiling or overhang or it may be configured to be positioned onto a surface such as a table, chair, etc. However, it should be appreciated that image display devices may include cathode ray tubes (CRTs), flat panel liquid crystal displays (LCDs) systems, light emitting diode (LED) systems, plasma systems, rear projection systems, LCD monitors, hand-held devices, etc.

Continuing with FIG. 1, image display device 100 may include housing 130, light source 180, image generating element 150, projection lens 110, control system 140, and illuminated status indicator (CSI) 120. Housing 130 fully or partially encloses light source 180, image generating element 150, projection lens 110, and control system 140. Light source 180 may be configured to direct light toward image generating element 150. In some embodiments, the light source may include a lamp positioned within a reflector that may be configured to direct most of the emitted light along an optical path of the system. The light source may include any suitable type of lamp or light source, including but not limited to, metal halide lamps and ultra-high-pressure (UHP) arc lamps, lasers, light emitting diodes (LED), organic light emitting diodes, etc. Such a system may also include one or more filters, such as an infrared (IR), or ultraviolet (UV) filters, to filter out unwanted parts of the emission spectra of the lamp. Some light source technologies, such as metal hydride lamps, may require a warm-up period before the full light capacity may be reached and the emission spectra of the lamp are stable. This warm-up period, which may be several minutes long, is one component of the image display device warm-up period, when the device may appear non-responsive.

Image generating element 150 may be configured to receive light from light source 180, and in response, generate an image. The image generating element may include an optical engine, image-producing element, filters, color wheels, lenses, mirrors, integrators, condensers, and other suitable optical elements. Such elements may be configured to generate an image. For example, the image generating element may include an image-producing element, such as, but not limited to, a digital micromirror (DMD), an LCD panel, or any other suitable image source. In some embodiments, the image-producing element may be configured to project light toward one or more lenses, mirrors or other optics, which, in turn, may be configured to project light toward the viewing surface. In some embodiments, a projection lens such as projection lens 110 may be configured to display the image on the viewing surface. Non-limiting examples of the viewing surface may include a screen, a wall, etc.

Continuing with FIG. 1, image display device 100 may further include control system 140. Control system 140 may include a microprocessor, volatile and non-volatile memory, and peripheral logic associated with image display device 100. Control system 140 may be implemented with discrete electronic components, with a system on chip (SOC), or combinations thereof. Non-volatile memory may be used to store instructions for the microprocessor and may include read-only memory (ROM), a hard disk drive, etc. Volatile memory may be used for storing instructions, storing the status of image display device 100, processing data, etc. Examples of volatile memory are static random access memory (SRAM), dynamic random access memory (DRAM), etc. Control system 140 may receive input from input device 170 and from external interface 160. Input devices may include a remote control, a keypad, etc. External interfaces may include a variety of networking and/or video interfaces including Ethernet, USB, VGA, HDMI, S-video, DVI, etc.

Control system 140 may be configured to provide the overall control for image display device 100. Control may be provided through a combination of instructions encoded in control system memory and input received from input device 170. For example, control system 140 may receive image data from external interface 160, process the image data, and send the data to image generating element 150 for display. As another example, control system 140 may receive a power-on command from a remote control input device and begin a power-on sequence. As another example, control system 140 may be configured to sequence events in image display device 100, such as power-on, warm-up, shut-down, power-off, etc. Control system 140 may also be configured to indicate the status of image display device 100 via an illuminated status indicator or conspicuous status indicator (CSI) 120. For example, control system 140 may associate a CSI mode to one or more status conditions of image display device 100, where each CSI mode may determine the illumination of CSI 120.

As described in more detail below the illuminated status indicator, also referred to herein as conspicuous status indicator (CSI) 120, may be disposed such that it is viewable by a user when the user is looking at a face of the housing. For example, in some embodiments, the illuminated status indicator may be positioned adjacent a projection lens which is generally on the face of the housing. In one example, the illuminated status indicator may be used to provide status information to a user, such as when an illumination device is powering on and/or powering off. The position of the illuminated status indicator may be conspicuous to a user without disrupting operation of the image display device.

CSI 120 may provide a visual signal to a user indicating the status of image display device 100. The visual signal may be varied to indicate different image display device states. CSI 120 may include a single segment or a plurality of segments. The illumination of each CSI segment may be varied from off to fully-on and intensities in between. Varying the illumination over time may produce different patterns on a CSI segment. For example, alternately turning the CSI segment on and off may produce a flashing, or blinking, pattern. Coordinating the illumination between multiple CSI segments may produce additional visual signals.

In an example embodiment, CSI 120 may be a glow ring or partial glow ring mounted on a face of housing 130. In some embodiments, the illuminated status indicator, or glow ring, in this example, may extend partially around a peripherary region or a portion of a lens, such as a projection lens. In other examples, the illuminated status indicator may substantially encircle or fully encircle the lens. The ring may glow, pulsate, and/or vibrate to provide user feedback regarding the status of image display device 100. For example, CSI 120 may glow, pulsate, and/or vibrate in order to give the user feedback that image display device 100 is powering up or powering down. Such glowing, pulsating, and/or vibrating may occur in a synchronous or asynchronous manner.

CSI 120 may use different colors to indicate the status levels of image display device 100. Each segment may use a single color or a plurality of colors. A plurality of segments may use a single color or a plurality of colors. For example, CSI 120 may be a single color and single intensity to give direct feedback regarding response from the user's control. In other embodiments, different colors and/or different intensities may provide different information to the user regarding the status of image display device 100.

CSI 120 may use patterns, such as color patterns, to increase information to the user regarding the status of image display device 100. For example, a first changing color pattern illuminated on CSI 120 may indicate power-on of image display device 100. A second changing color pattern illuminated on CSI 120 may indicate power-off, for example. A third color pattern illuminated on CSI 120 may indicate that image display device 100 is ready to display images. Further still, a fourth color pattern illuminated on CSI 120 may indicate an error occurred on image display device 100.

In some embodiments, CSI 120 may include a plurality of segments such that each segment may be illuminated with a different color and/or brightness. For example, a glowing ring may gradually light up in a clockwise direction to indicate that image display device 100 is powering up. Conversely, the glowing may gradually switch off in a counter-clockwise direction to indicate that image display device 100 is powering down. The glowing ring may include one or more LED segments configured to be synchronously or asynchronously lighted. Thus, in some examples, the LED segments may light up consecutively in the clockwise direction to indicate powering up, and turn off consecutively in the counterclockwise direction to indicate powering down. In some cases, a plurality of LED segments may light up or turn off concurrently.

It should be appreciated that the variables of color, intensity, and time may be varied singly or in combination for one segment and/or for multiple segments to indicate one or more status conditions of the image display device.

It is noted that CSI 120 may further provide an identification feature for image display device 100. For example, a plurality of image display devices may each have a CSI that is configured in a different way so that a user may promptly identify a particular image display device. As one example, a plurality of image display devices may each include a CSI with different colors. In this way, a CSI may further be used to enhance the source recognition of the image display device.

Moreover, in some embodiments the color of CSI 120 may be customized to enable the user to personalize image display device 100. For example, the user may be given an option to purchase image display device 100 configured with CSI 120 that matches a school or organization color or pattern. Customized shapes may be used to further enhance the aesthetic appeal of the status indicator.

In an example embodiment, CSI 120 may be an injection molded circular light pipe with one or more light emitting diodes (LEDs) as backlight(s). The light pipe may be attached to the front bezel of housing 130 around the circumference (or partial circumference) of projection lens 110. The ring formation and size of the ring may provide an easily identifiable indicator of status, such as a warm-up or shut-down mode. Furthermore, the intensity of each LED may be selectively controlled, in this embodiment. In an alternative embodiment, a backlight for the CSI may include an incandescent bulb or other light source. A feature of the CSI backlight is that illumination occurs shortly after power is applied so that the user may receive prompt visual feedback.

The position of CSI 120 prevents CSI 120 from interrupting display by image display device 100. It should be appreciated that CSI 120 may be turned off or intensity reduced after image display device 100 is fully powered up or during projection of images in some embodiments. However, in other embodiments, CSI 120 may be constant throughout power-up, projection, etc.

CSI 120 may be configured such that it is of substantial size and/or have substantial illumination intensity so that the user may spot CSI 120 from a distance. Such size and illumination intensity may enable the user to promptly identify the status of image display device 100, even when the user is at a remote distance from image display device 100. Such feedback to the user of image display device 100 will decrease frustration with image display device 100 and increase ease of use. For example, the user may be able to promptly identify if there is an issue with a remote control input device or if the delay is due to image display device 100 powering up. In one example, the size and/or illumination intensity of CSI 120 allows a user to view CSI 120 at a distance of 20 feet with a human eye.

It is noted that the position of CSI 120 may be such that the user can promptly identify the status of image display device 100. One method for making CSI 120 promptly identifiable is to mount CSI 120 in a prominent place on housing 130. Housing 130 may be generally box-like, with a plurality of faces. When housing 130 is a box, housing 130 will have six faces (top, bottom, left, right, front, and back). It will be appreciated, that other shapes may be used for the enclosure, each shape potentially having a different number of faces. In an example embodiment, the opening for projection lens 110 may be oriented on a single face of housing 130, such that light may pass from projection lens 110 to the viewing surface. During operation, image display device 100 may be positioned such that there is a clear path from projection lens 110 to a display surface so that the image may be projected onto the display surface. The user often has a clear view of projection lens 110 and the display surface so placing CSI 120 on the same face and adjacent to projection lens 110 may allow the user to promptly identify CSI 120 when the user looks toward projection lens 110.

FIG. 2 illustrates one view of an example embodiment of image display device 200 where the projection lens and CSI are positioned on the same face of the housing. Front face 230 has an opening for projection lens 110 and two CSI segments 220a and 220b. The vertical openings on front face 230 are part of an airflow system which enable airflow into and out of the housing so that the electronic components and the light source may be cooled. The pattern of openings is also called the venting pattern. Right face 240 and top face 250 are also visible from this orientation of the example embodiment. Keypad 270 may be used as an input device 170 as well as a remote control (not shown).

FIG. 3 illustrates a second view of image display device 200. Rear face 330, left face 340, top face 250, and keypad 270 are visible in this view. In this example, CSI segments 220a and 220b cannot be viewed from the perspective of FIG. 3. However, it may be appreciated that the CSI may be placed at any location on or in the image display device. Further still, more than one CSI may be located on the image display device such that the status of the image display device may be detected from more than one perspective. For example, a ceiling mounted projector's most visible face may be the bottom face, and thus the bottom face may be a good choice for the CSI of this image display device.

FIGS. 4A-4H are schematic representations of example front faces of housing 130. FIGS. 4A-4H illustrate examples of the spatial relationship between projection lens 110 and CSI 120. Different example configurations of CSI 120 are also shown. Other components of the housing, such as venting patterns, are not shown in these schematic representations. The absence of venting patterns in the schematics does not imply the presence or absence of venting on any of the example faces. FIGS. 4A-4H are provided as example illustrations of CSI configurations and are not intended to limit in any way the position or shape of the CSI.

FIG. 4A shows a schematic representation of front face 230 in FIG. 2. Front face 230 has openings for projection lens 110 and for two CSI segments 220a and 220b. Projection lens 110 is near the center of front face 230. CSI segments 220a and 220b form two arcs that partially extend along the periphery of the projection lens or projection lens opening in the housing. In alternative embodiments, different shapes, such as lines may extend along a portion of a projection lens periphery. CSI segments may partially or substantially encircle the projection lens. CSI segments 220a and 220b may be illuminated synchronously or independently. CSI segments 220a and 220b may be illuminated with the same color and/or brightness or CSI segments 220a and 220b may be illuminated with different colors and/or brightness.

FIG. 4B shows an example embodiment of a face of housing 130 where projection lens 110 is near the center of the face and the CSI includes a single segment 412 that forms a continuous ring around the full periphery of projection lens 110. Face 413 has an opening or openings for projection lens 110 and for CSI segment 412. Face 413a is the portion of the face 413 beyond the periphery of CSI segment 412. Annular gap 413b between projection lens 110 and CSI segment 412 may be part of the face or it may be left open. In an alternative embodiment, CSI segment 412 may be flush with projection lens 110 so there may not be an annular gap. Although CSI segment 412 is in a generally circular, or ring-like shape, it should be appreciated that CSI segments may be of any suitable shape. CSI segment 412 may illuminate in a single color, such as blue, for example, or CSI segment 412 may illuminate in multiple colors.

FIG. 4C shows an example embodiment of a face of housing 130 where projection lens 110 is off-center, near the left side, of the face and the CSI includes a plurality of segments 422a-d that form a continuous ring around the full periphery of projection lens 110. Face 423 has an opening or openings for projection lens 110 and for the plurality of CSI segments 422a-d. Face 423a is the portion of the face 423 beyond the periphery of the plurality of CSI segments 422. Annular gap 423b between projection lens 110 and the plurality of CSI segments 422 may be part of the face or it may be left open. In an alternative embodiment, the plurality of CSI segments 422 may be flush with projection lens 110 so there may not be an annular gap.

FIG. 4D shows an example embodiment of a face of housing 130 where projection lens 110 is off-center, near the right side, of face 433. The CSI includes a plurality of CSI segments 432 that is concentric to projection lens 110 and that encircles projection lens 110. In an alternative embodiment, the plurality of CSI segments may be non-concentric with projection lens 110 and/or the plurality of CSI segments may partially encircle the projection lens. Each CSI segment may illuminate independent of the other CSI segments, or the illumination may be coordinated with the other CSI segments to form illuminated patterns.

FIG. 4E shows the embodiment from FIG. 4D illuminated in an example pattern. Break-lines 446a and 446b indicate that the CSI segments may partially or completely encircle projection lens 110. CSI segments 432a-b are illuminated (on) and CSI segments 432c-e are not illuminated (off). A growing pattern may be generated by keeping CSI segments 432a-b illuminated and then illuminating CSI segment 432c. When some time has passed, keeping CSI segments 432a-c illuminated and then illuminating CSI segment 432d will continue the growing pattern. This pattern proceeds in a counter-clockwise manner as shown by arrow 445, but the pattern may proceed in a clockwise manner in an alternative embodiment. The growing pattern may be useful for showing the passage of time. For example, all CSI segments may be off at the beginning of some period and successive CSI segments may be illuminated with the passage of time until all CSI segments are illuminated at the conclusion of the time period. Alternatively, a subset of CSI segments may be illuminated when a time period expires.

Returning to the original conditions, when CSI segments 432a-b are illuminated and CSI segments 432c-e are not illuminated (off), a circulating pattern may be generated by turning off CSI segment 432a and illuminating 432c, such that 432b-c are illuminated. The pattern may be advanced after some time has passed by turning off CSI segment 432b and illuminating 432d, such that 432c-d will be illuminated. In this example, the circulating pattern includes two CSI segments illuminated concurrently, but alternative embodiments may use from one to N−1 CSI segments for the illuminated portion of the pattern, where N is the total number of CSI segments.

FIG. 4F shows the embodiment from FIG. 4D illuminated in an alternative example pattern. CSI segments 432a-c are illuminated and CSI segments 432d-e are not illuminated (off). A shrinking pattern may be generated by keeping CSI segments 432a-b illuminated and switching CSI segment 432c off. When some time has passed, keeping CSI segment 432 an illuminated and then switching CSI segment 432b off will continue the shrinking pattern. This pattern proceeds in a clockwise manner as shown by arrow 455, but the pattern may proceed in a counter-clockwise manner in an alternative embodiment.

Each CSI in FIGS. 4A-4F has been generally circular and has substantially or partially surrounded the projection lens, but many different shapes and orientations may be used for the CSI. FIG. 4G shows an example embodiment where projection lens 110 is near the right side of face 463 and CSI 462 is near the left side of face 463. In this example embodiment, CSI 462 includes five CSI segments 462a-e. FIG. 4H shows an example embodiment where projection lens 110 is near the right side of face 473 and a single segment CSI 472 is near the center of face 473.

The example faces in FIGS. 4A-4H are rectangular, but housing 130 is not so limited. Each of the faces may be other polygons, such as a square or triangle for example. Housing 130 may even be spherical in which case housing 130 would have a single face encompassing the surface area of the sphere. Although the CSI in FIGS. 4A-4H are shown near or extending around the projection lens opening, in other embodiments the CSI may extend along other image display device housing features. For example, the CSI may be part of the venting pattern, part of the edge shaping, the exhaust outlets, the keypad, etc. Thus, the CSI may be substantially integrated with one or more of the venting pattern, edge shaping, exhaust outlets, keypad, etc.

FIGS. 2-4H have described image display devices that are projectors but, a CSI may also be placed on an image display device that is not a projector. FIG. 5 shows an alternative embodiment of an image display device that is a handheld device. Image display device 500 includes housing 530, CSI 520, image generating element 550, input device 570, and external interface 560. Housing 530 may have a clear panel or opening such that image generating element 550 may be directly viewed. A projection lens may not be required for this embodiment. The light source may be a backlight enclosed in housing 530 or the light source may be the ambient light striking image generating element 550. Different handheld devices may be used in many different ways and so the status indicated by CSI 520 may vary depending on the function of handheld device 500. For example, functions such as charging a battery, synchronizing to a base-unit, and receiving new information or an incoming call may be indicated by CSI 520. CSI 520 may be preferable for displaying simple information versus image generating element 550, to conserve power, to be more private, etc.

FIG. 6 illustrates a high-level flowchart for an example routine 600 that may be executed by control system 140 to carry out a control method for CSI 120, with at least one segment, coupled to image display device 100 having a light source 180 and an image generating element 150. In one example, the method includes determining a current image display device state from a plurality of image display device states, associating the current image display device state to a desired illuminated status indicator mode, and adjusting an illuminated status indicator illumination according to the desired illuminated status indicator mode.

Returning to routine 600, at 610, the routine determines if a change in image display device state has been detected. Non-limiting examples of image display device states may include: power-on, warm-up, display operational, device processing, battery charging, shut-down, power-off, error condition, external interface activity, input device activity, and combinations thereof. The power-on state may include when image display device 100 was off and a power switch has been depressed on an input device such as a remote control, keypad, or stand-alone power switch. The warm-up state may include the period after power-up during which light source 180 is warming up and before an image may be displayed on image generating element 150. The display operational state may include the period when an image may be displayed on image generating element 150. The device processing state may include times when image display device 100 is performing internal calculations, such as adjusting colors or resolution, and is unable to display an image on image generating element 150. The battery charging state may include when a battery is being charged when image display device 100 has a rechargeable battery. The shut-down state may include when image display device 100 was on and a power switch has been depressed on an input device such as a remote control, keypad, or stand-alone power switch. The shut-down state may further include when light source 180 is being cooled prior to disconnecting power. The power-off state may include when power may be disconnected from a majority of components within image display device 100. The error condition state may include when light source 180 needs to be replaced or when other conditions are present that may require special attention. The external interface activity state may include when an external device is properly connected to image display device 100 and when activity is detected on the external interface. The input device activity may include when activity is detected on an input device such as a keypad or remote control.

Returning to 610, the routine determines if a change in image display device state has been detected. For example, a user may press a button on a remote control input device signaling an interrupt to control system 140. The change may be detected by an interrupt service routine or a polling routine running on a microprocessor within control system 140, for example. If a change in image display device state is detected, the routine proceeds to 630. If no change in display device state is detected, the routine proceeds to 620. At 620, the current illumination is maintained on CSI 120. Routine 600 ends after 620.

At 630, the current image display device state is determined by a subroutine like routine 700, for example. The subroutine begins when control passes from 630 to routine 700. Control passes back to 630 when routine 700 ends. It will be appreciated that routine 700 may be a set of steps coded in-line with routine 600. Routine 600 proceeds from 630 to 640.

At 640, the current image display device state is associated with a CSI mode that determines how CSI 120 may be illuminated. In this way, the status of image display device 100 is linked to a visual signal that may be viewed by the user. Non-limiting examples of image display device states may include: power-on, warm-up, display operational, device processing, battery charging, shut-down, power-off, error condition, external interface activity, input device activity, and combinations thereof. Some or all of these image display device states may be associated with a visual signal that is determined by the CSI mode. Non-limiting examples of CSI modes may include: off, on, pulsate, flash, vibrate, circulate, grow, and shrink. The off CSI mode may include switching off one or more CSI segments. The on CSI mode may include illuminating one or more CSI segments. The pulsate, flash, and vibrate CSI modes are similar in that they may include alternately brightening and dimming one or more CSI segments. Flash may switch between fully illuminated and off at a regular interval. Pulsate may gradually vary the intensity between fully illuminated and off at a regular interval. Vibrate may switch between fully illuminated and off at a varying interval. The circulate CSI mode may generate a pattern where one or more CSI segments may illuminate in a circulating pattern as described in FIG. 4E. The grow CSI mode may generate a pattern where the number of illuminated CSI segments increase over time as described in FIG. 4E. The shrink CSI mode may generate a pattern where the number of illuminated CSI segments decrease over time as described in FIG. 4F. These modes are exemplary in nature, and are not intended to be limiting in any way. Routine 600 proceeds from 640 to 650.

At 650, the illumination of CSI 120 is adjusted according to the CSI mode that was determined at 640. The illumination is adjusted by a routine like routine 800, for example. The subroutine begins when control passes from 650 to routine 800. Control passes back to 650 when routine 800 ends. It will be appreciated that routine 800 may be a set of steps coded in-line with routine 600. Routine 600 ends after 650.

Executing a routine, such as routine 600, may make it possible for CSI 120 to visually indicate the status of image display device 100. When CSI 120 is mounted in an illuminated place on housing 130, such as the face with projection lens 110, a user may promptly identify the status of image display device 100. The visual feedback afforded by CSI 120 may help the user identify a reason for delay, such as the warm-up period, or a source of trouble, such as a non-functioning remote control. As such, the responsiveness of CSI 120 may decrease the frustration of the user of image display device 100.

FIG. 7 illustrates a high-level flowchart for an example routine 700 that may be executed by control system 140 to carry out a control method to determine the current image display device state. At 710, it is determined if a change in power-state has been detected. If a change in power-state is detected, the routine proceeds to 720, otherwise, the routine proceeds to 730. At 720, the individual components of the power-state may be examined. The state of the power-switch may be examined to determine if it is switched on or switched off. A power-on flag may be set when the power-switch is in the on position and the power-on flag may be cleared when the power-switch is in the off position. When image display device 100 is switched on, a warm-up timer may begin. The warm-up timer may be used to determine when light source 180 is ready. A warm-up flag may be set when the warm-up timer begins and the warm-up flag may be cleared when the warm-up timer completes. A shut-down timer may be used to determine when power may be removed from the electronic components of image display device 100. The shut-down timer may be used to determine how long to cool light source 180 before removing power, for example. The shut-down timer may start when the power-switch is switched to the off position. A shut-down flag may be set when the shut-down timer begins and the shut-down flag may be cleared when the shut-down timer ends. The combination of the power-on flag, the warm-up flag, and the shut-down flag may be used to determine the power status of image display device 100. For example, when the power-on flag is set, the warm-up flag is set, and shut-down timer is clear, image display device 100 may be in the warm-up state. As another example, when the power-on flag is set, the warm-up flag is clear, and shut-down timer is clear, image display device 100 may be in the display operational state. From 720, routine 700 proceeds to 730.

At 730, it is determined if there is any activity detected on the external interface. If activity is detected, the routine proceeds to 735 where an external-activity flag may be set before proceeding to 750. If external activity is not detected, the routine proceeds to 740 where the external-activity flag may be cleared before proceeding to 750.

At 750, it is determined if there is any activity detected on the input device. If activity is detected, the routine proceeds to 755 where an input-activity flag may be set before proceeding to 770. If activity on the input device is not detected, the routine proceeds to 760 where the input-activity flag may be cleared before proceeding to 770.

At 770, it is determined if image display device 100 is ready to display images. Image display device 100 may be ready when the power switch is on, the warm-up period is complete, the shut-down timer is not active, and control system 140 is able to send image data to image generating element 150. For example, control system 140 may be initializing buffers, scaling an image, converting colors, or performing an internal processing task, such that control system 140 may be unable to send image data temporarily. If image display device 100 is ready, the routine proceeds to 775 where a ready flag may be set before ending routine 700. If image display device 100 is not ready, the routine proceeds to 780 where the ready flag may be cleared before ending routine 700. When routine 700 is completed, the set of flags may define the state of image display device 100.

FIG. 8 illustrates a high-level flowchart for an example routine 800 that may be executed by control system 140 to carry out a control method to adjust CSI illumination according to the CSI mode. At 810, it is determined if the CSI mode is off. If the CSI mode is not off, the routine proceeds to 820. If the CSI mode is off, the routine proceeds to 815 where one or more of the CSI segments may be switched off. All of the CSI segments may be switched off or a subset of the CSI segments may be switched off. A mask may be used to control which CSI segments are switched off, for example. Routine 800 ends after 815.

At 820, it is determined if the CSI mode is on. If the CSI mode is not on, the routine proceeds to 830. If the CSI mode is on, the routine proceeds to 825 where one or more of the CSI segments may be illuminated with one or more colors and/or intensities. All CSI segments may be illuminated with the same color and/or intensity or each CSI segment may be illuminated with a different color and/or intensity. For example, a data structure may associate an intensity and/or color to each CSI segment. Routine 800 ends after 825.

At 830, it is determined if the CSI mode is pulsate. If the CSI mode is not pulsate, the routine proceeds to 840. If the CSI mode is pulsate, the routine proceeds to 835 where one or more of the CSI segments may be illuminated with a pulsating pattern. The pulsating pattern includes varying the CSI illumination intensity from a maximal intensity (bright) to a minimal intensity (dim) and from dim to bright in an alternating manner. The maximal and minimal intensity of the illumination may be varied to produce different visual effects. The period between maximal and minimal intensity may also be varied as may the time rate of change of illumination intensity. Routine 800 ends after 835.

At 840, it is determined if the CSI mode is circulate. If the CSI mode is not circulate, the routine proceeds to 850. If the CSI mode is circulate, the routine proceeds to 845 where the CSI segments may be illuminated with a circulating pattern as described in FIG. 4E. The intensity of illumination, the direction and period of revolution, and the number of CSI segments illuminated may be varied to produce different visual effects. Routine 800 ends after 845.

At 850, it is determined if the CSI mode is grow. If the CSI mode is not grow, the routine proceeds to 860. If the CSI mode is grow, the routine proceeds to 855 where the CSI segments may be sequentially illuminated with a growing pattern as described in FIG. 4E. The intensity of illumination, the time period between illuminating CSI segments, and the starting CSI segment may be varied to produce different visual effects. Routine 800 ends after 855.

At 860, it is determined if the CSI mode is shrink. If the CSI mode is not shrink, routine 800 ends. If the CSI mode is shrink, the routine proceeds to 865 where the CSI segments may be sequentially switched off with a shrinking pattern as described in FIG. 4F. The intensity of illumination, the time period between switching off CSI segments, and the initial number of illuminated CSI segments may be varied to produce different visual effects. Routine 800 ends after 865.

In this way, a routine like routine 800 may associate a CSI mode with a visual pattern to be displayed on CSI 120. As described in the example routine 800, each CSI mode was associated with a single illumination pattern of CSI 120. In an alternative embodiment, each CSI mode may include multiple illumination patterns. For example, a pulsating and growing pattern may be combined to illuminate CSI 120.

Note that the example control routines included herein can be used with various image display device configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be encoded as microprocessor instructions and stored into the computer readable storage medium in the control system of the image display device.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. An image display device comprising:
a light source;
an image generating element configured to receive light from the light source, and in response, generate an image;
a projection lens configured to display the image on a viewing surface;
an illuminated status indicator configured to visually indicate a status of the image display device and extending at least partially around the projection lens;
a control system in communication with the light source, the image generating element, and the illuminated status indicator; and
a housing comprised of a plurality of faces, where the housing encloses the light source, the image generating element, and the control system and where the illuminated status indicator is viewable by a user when the user is looking at a face of the housing.

2. The image display device of claim 1 wherein the illuminated status indicator substantially encircles the projection lens.

3. The image display device of claim 1 wherein the illuminated status indicator includes a plurality of segments.

4. The image display device of claim 1 wherein the status indicator provides information regarding at least one of power-on, warm-up, display operational, device processing, battery charging, shut-down, power-off, error condition, external interface activity, and input device activity.

5. A method for operating an image display device, the image display device having a light source, an image generating element, and an illuminated status indicator, the illuminated status indicator having one or more segments, the method comprising:
determining a current image display device state from a plurality of image display device states;
associating the current image display device state to an illuminated status indicator mode; and
adjusting an illuminated status indicator illumination according to the illuminated status indicator mode where the illuminated status indicator extends at least partially around a projection lens.

6. The method of claim 5 wherein one image display device state is when the image display device is warming-up.

7. The method of claim 5 wherein one image display device state is when the image display device is shutting-down.

8. The method of claim 5 wherein the illuminated status indicator includes light emitting diodes.

9. The method of claim 5, wherein adjusting the illuminated status indicator includes displaying a light pattern to indicate an illuminated status indicator mode.

10. The method of claim 5 wherein a first illuminated status indicator mode is associated with illuminating all segments of the illuminated status indicator to a substantially similar intensity and color.

11. The method of claim 5 wherein a second illuminated status indicator mode is associated with illuminating a first segment of the illuminated status indicator with a first color and illuminating a second segment of the illuminated status indicator with a second color.

12. The method of claim 5 wherein one illuminated status indicator mode is associated with illuminating the illuminated status indicator with a pulsating pattern.

13. The method of claim 5 wherein the illuminated status indicator includes a plurality of segments that substantially encircle a projection lens and wherein a second illuminated status indicator mode is associated with illuminating the illuminated status indicator with a circulating pattern.

14. The method of claim 5 wherein one illuminated status indicator mode is associated with illuminating the illuminated status indicator with a growing pattern.

15. The method of claim 5 wherein one illuminated status indicator mode is associated with illuminating the illuminated status indicator with a shrinking pattern.

16. A system for an image display device, comprising:
a light source;
an image generating element configured to receive light from the light source, and in response, generate an image;
a projection lens configured to display the image on a viewing surface;
an input device;
an external interface;
an illuminated status indicator configured to visually indicate a status of the image display device;
a control system in communication with the light source, the image generating element, the input device, the external interface, and the illuminated status indicator;
a housing comprised of a plurality of faces, the housing enclosing the light source, the image generating element, and the control system and wherein a first face of the housing is configured with an opening where light can pass from the projection lens to the viewing surface, and wherein the first face of the housing is coupled to the illuminated status indicator; and
computer readable storage medium having instructions encoded therein, including:
instructions for determining a current image display device state from a plurality of image display device states;
instructions for associating the current image display device state to an illuminated status indicator mode; and
instructions for adjusting an illuminated status indicator illumination according to the illuminated status indicator mode.

17. The system of claim 16 wherein the illuminated status indicator at least partially encircles the projection lens.

18. The system of claim 16 wherein the plurality of image display device states include one or more of power-on, warm-up, display operational, device processing, battery charging, shut-down, power-off, error condition, external interface activity, input device activity, and combinations thereof.

19. The system of claim 16 wherein the illuminated status indicator mode is selected from one or more of off, on, pulsate, flash, vibrate, circulate, grow, and shrink.
